(19) United States
(12) Patent Application Publication
(10) Pub. No.: US 2006/0259493 A1
(43) Pub. Date: Nov. 16, 2006

(54) Community Based Content Remover

(76) Inventor: Ken Zhiyi Liang, Draper, UT (US)

Correspondence Address: Mr.Ken Zhiyi Liang, 633 E Hollow Creek Rd, Draper, UT, 84020, US

(21) Appl. No.: 10/908,498

(22) Filed: May 14, 2005

(51) Int. Cl. G06F 17/30

(52) U.S. Cl. 707/10

(57) ABSTRACT

A community based content remover and method for removing the same is provided. In one embodiment, the community based content remover comprises a content, a corresponding content removal link, and a content control. The content control signals the content and the corresponding content removal link to a community of client systems to be actualized. Once a preselected number of unique client systems at least 2, signaled the corresponding content removal link to the content control, the content control no longer signals the content to the community of client systems.

The following are definitions for this patent.

A “content” is comprised of visual and/or audio information. Generally, the content is comprised of words or pictures. The content may have different colors. The content could also be sounds. The content does not have to make sense or be understandable by any particular person.

A “corresponding content removal link” is an unique identifier that is associated with a particular content. Generally a corresponding content removal link is a clickable item (such as a hyperlink or a button) on a computer screen, and when clicked, the corresponding content removal link informs a content control of it being clicked and the content that it is associated with.

A “content control” is a unit that has the ability to display a content upon a client system when signaled by the client system. Generally, a content control is a computer server and/or a computer program that can determine what content to send to a client system when requested.

A “client system” is something that can actualize the content, such as by displaying the content on a computer screen if the content is visual, or by sounding the content on a speaker if the content is audio.

An “internet” describes the internet, a network or any means that can be used to connect the client systems to the content control.

A “web site” refers to a web site, a computer application software, or anything that can function as a content control and send the content to the client systems.

The foiling is a background on this patent

On the internet, a web site can allow people to enter information, submit pictures, record sounds, upload files, or post information (these items hereafter collectively known as “contents”). This web site may then choose to display or make available, some or all of the contents to the internet. One problem for the web site when allowing people to submit contents is this: how to remove the offensive contents. Offensive contents are defined as contents that generally offend the visitors of the web site or violate the terms of use of the web site.

One partial solution of removing the offensive contents is to use a screening software. However, the drawback is that people can easily bypass the screening software with clever spelling of words. Also, some contents may be offensive only in a certain context, and a screening software cannot make such a distinction. Another drawback is that a screening software may remove desirable contents, which in itself would be an offensive activity. Thus, screening software is not a solution.

Another partial solution is to hire employees to manually review the contents and then delete each offensive post. There are 2 problems with this method. First, it is very costly. Most web sites do not have the resource to hire many people to manually review each content, thus making this method impossible to implement for most web sites. Second, the employees do not know what is offensive for the web site. Depending on the demographics of the visitors, the meaning of “offensiveness” changes. To let the employees decide on which content to remove gives too much discretion to the employees, even if there is a guideline. Due to the great cost and uneven application of the removal, to hire employees to remove offensive contents is not a solution.

Another partial solution is to allow visitors of the web site to report the offensive contents to the web site, and then have the employees of the web site remove the contents. This again has the same 2 problems discussed in the previous paragraph. First, although some of the screening work are done by visitors, each report must still be viewed by an employee of the web site. If there are many contents, and many reports, then many employees must still be hired. This is still a costly method. The second problem is that once the offensive contents are reported to the employees of the web site, it is still up to the employees' discretion to remove the contents. The employees still have discretion on whether to keep the contents. Thus, having visitors report offensive contents to the web site does not solve the problem.

On the other hand, a Community Based Content Remover solves this problem of how to remove offensive contents. The core idea behind the Community Based Content Remover is that once a certain number of visitors of the web site reports that a content is offensive, then that content is automatically removed. To implement this system or method, the web site may also allow only certain visitors to report the offensive contents, and may hinge the removal of a content based on reaching a certain number of reports, or reaching a certain number of reports within a time frame.

The Community Based Content Remover is a scale free solution to removing offensive contents. First, there is no marginal cost to the web site for removing the offensive contents. Visitors read and find the offensive contents, and visitors click on the corresponding removal link to remove the contents. The web site has no incremental cost with removing contents. By not having web site employees doing the content removal work, there is no labor cost, and so this solution is applicable to a web site of any size.

Second, the Community Based Content Remover can remove offensive contents to a particular internet community, as opposed to removing offensive contents to a particular employee. If many visitors of the web site believe that a content is offensive, then by definition, that content is offensive to that community. Offensive contents are removed though a rather democratic voting method.

By requiring a certain number of visitors to report on a content before removing it, it is possible that an offensive content that no one reads is not removed. However, an offensive content that is not read by any visitor cannot be offensive because there is no one that it can offend.

In conclusion, the Community Based Content Remover can remove offensive contents at a web site.

### SUMMARY OF THE PATENT

In light of the foregoing, here is an example of how to make and use the Community Based Content Remover. A client system (such as a end user computer) can signal (such as through a network) to a content control (such as a web server), to display a content (such as a forum post) on the client system. Along with the content, the content control also displays a corresponding content removal link (such as a hyperlink) with each content. Upon finding an objectionable content, the client system may signal to the content control that it does not like the content by clicking on the corresponding content removal link. Once clicked, the content control remembers that a client system clicked on the corresponding content removal link. When a preselected number of unique client systems at least 2, have signaled the corresponding content removal link of the content to the content control, the content control no longer displays the content to any client system, even when requested by the client system. The preselected number of unique client systems must be at least 2, because at least 2 are necessary to be a community.

The advantage of the Community Based Content Remover is that it can create an orderly community of any size. Members of the community use the Community Based Content Remover as a voting method do remove objectionable contents. No moderator is needed to remove the contents. The content is automatically removed if enough people clicked on the corresponding content removal link.

The preselected number of unique client systems must be at least 2, and the client systems must be unique from each other.

The “at least 2” creates a community. A higher number may be preselected to ensure that a content is removed only when a certain percentage of the people within the community agrees to the removal.

### DESCRIPTION OF THE DRAWING

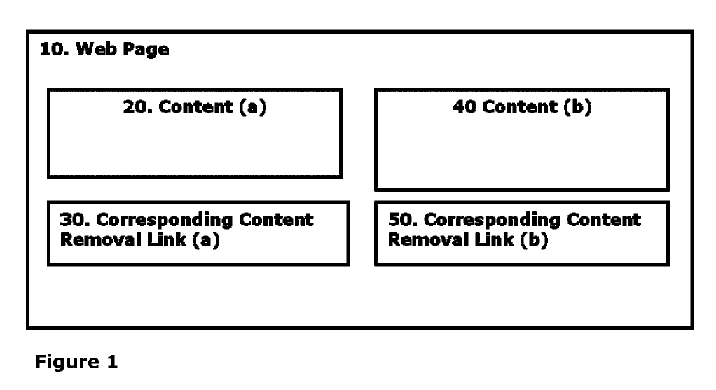

The invention can be understood with reference to the following drawing. The components in the drawing are not necessarily to scale. FIG. 1:

The above FIG. 1 shows a Web Page 10, that is displayed on a client system. A Content (a) 20, is associated with and identified by a Corresponding Content Removal Link (a) 30, and both contained in the Web Page 10. A Content (b) 40 is associated with and identified by a Corresponding Content Removal Link (b) 50. The Corresponding Content Removal Link (a) 30, and the Corresponding Content Removal Link (b) 50 may be a hyperlink or a button. The Corresponding Content Removal Link (a) 30, and the Corresponding Content Removal Link (b) 50 both can signal to the Content Control when clicked.

If the client system wants to remove the Content (a) 20, then the client system clicks on the Corresponding Content Removal Link (a) 30. Similarly, if the client system wants to remove the Content (b) 40, then the client system clicks on the Corresponding Content Removal Link (b) 50. Clicking on the Corresponding Content Removal Link (a) 30, has no effect on the Content (b) 40, because they do not correspond to each other.

When a preselected number of unique client systems at least 2, for example 5, have signaled the Corresponding Content Removal Link (a) 30, to the content control, the content control no longer displays the content (a) 20, to any client system. Once the content control does not display the content (a) 20, that content is considered to be removed.

What is claimed is:

1. A community based content remover, comprising:
a content, a corresponding content removal link, and a content control;
the content control can be signaled by a community of client systems,
the content control can display the content and the corresponding content removal link on the community of client systems;
the community of client systems may signal the corresponding content removal link to the content control; and
the content control does not display the content on the community of client systems, after a preselected number of unique client systems at least 2, have signaled the corresponding content removal link to the content control.

2. The community based content remover of claim 1, wherein the content comprises of visual information.

3. The community based content remover of claim 1, wherein the content comprises of audio information.

4. The community based content remover of claim 1, wherein the corresponding content removal link comprises a unique identifier that is associated to a particular content.

5. The community based content remover of claim 1, wherein the content control comprises a unit that has the ability to signal the content to the client system.

6. The community based content remover of claim 1, wherein the client system comprises display monitor that can display the content and the corresponding content removal link.

7. The community based content remover of claim 1, wherein the preselected number of unique client systems at least 2 comprises a value that can be changed.

8. The community based content remover of claim 1, wherein the preselected number of unique client systems at least 2 comprises a value that must be counted within a certain time frame.

9. A method for community based content remover, comprising:
providing a content, a corresponding content removal link, and a content control;
allowing the content control to be signaled by a community of client systems;
allowing the content control to signal the content and the corresponding content removal link to the community of client systems;
allowing the community of client systems to signal the corresponding content removal link to the content control; and
allowing the content control to not signal the content to the community of client systems, after a preselected number of unique client systems at least 2, signaled the corresponding content removal link.
